(19) United States
(12) Patent Application Publication
(10) Pub. No.: US 2026/0276893 A1
(43) Pub. Date: Sep. 17, 2026

(54) NEAR-EYE DISPLAY DEVICE

(71) Applicants: Interface Advanced Technology (Chengdu) Co., Ltd., Chengdu (CN); Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: SHANG-YU HUANG, Hsinchu (TW); YU-MEI KUO, New Taipei (TW)

(21) Appl. No.: 19/675,661

(22) Filed: May 13, 2026

Related U.S. Application Data
(63) Continuation-in-part of application No. PCT/CN2024/135767, filed on Nov. 29, 2024.

(51) Int. Cl. G02B 6/26

(52) U.S. Cl. CPC G02B 6/262

(57) ABSTRACT

A near-eye display device is provided. The near-eye display device includes a display screen, a light guide module and a defocus lens. The defocus lens receiving image light from the light guide module, has a first surface with a central region and a peripheral region. Integrated within the defocus lens are multiple microlenses, each convex towards the display screen. The near-eye display device allows the central region to focus a portion of the image light onto the user’s retina, creating a clear, sharp image. The microlenses focus a second portion of the image light in front of the retina.

### FIELD

The subject matter herein generally relates to displays, specifically a near-eye display device.

### BACKGROUND

With the advancement of technology, Virtual Reality (VR) technology has been applied in various fields, such as gaming, education, healthcare, and retail. The rapid increase in the myopic population has made it necessary for VR display devices to also meet the needs of this group.

Currently, common VR display devices on the market primarily address the needs of the myopic population by adding prescription lenses (concave lenses) into the optical path. However, after adding prescription lenses, due to their diverging effect, the image light exiting the VR display device is focused behind the retina of the myopic user’s eye. When a person with myopia wears such a VR display device, although the image light at the center of the field of view falls on the central retina to ensure clear vision, some image light falls behind the peripheral retina. This continuously stimulates the growth of the eye’s axial length, thereby accelerating the progression of myopia in the user’s eyes.

Therefore, there is room for improvement in the art.

### BRIEF DESCRIPTION OF THE DRAWINGS

Implementations of the present disclosure will now be described, by way of embodiment, with reference to the attached figures.

FIG. 1 is a structural diagram of a near-eye display device according to an embodiment of the present disclosure.

FIG. 2 illustrated an optical path of the near-eye display device shown in FIG. 1.

FIG. 3 is a structural diagram of a defocus lens used in the near-eye display device shown in FIG. 1.

FIG. 4 is a structural diagram of a microlens in the defocus lens shown in FIG. 3.

FIG. 5 is a structural diagram of a defocus lens according to another embodiment.

FIG. 6 is a curve showing a relationship between virtual image distance with different field of view angles for the near-eye display device in FIG. 1, simulating an observation effect of human eyes.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale, and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which references indicate similar elements. It should be noted that references to “an” or “one” embodiment in this disclosure are not necessarily to the same embodiment, and such references can mean “at least one”. The term “circuit” is defined as an integrated circuit (IC) with a plurality of electric elements, such as capacitors, resistors, amplifiers, and the like.

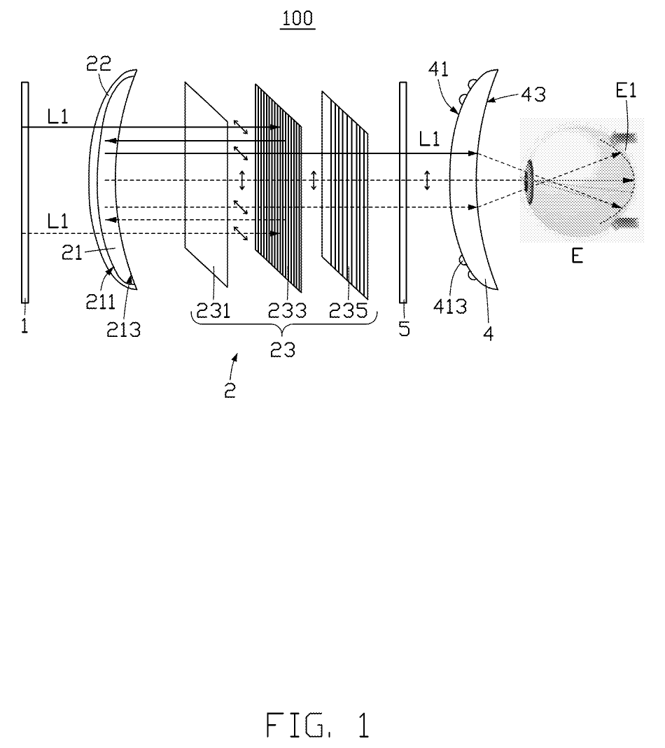

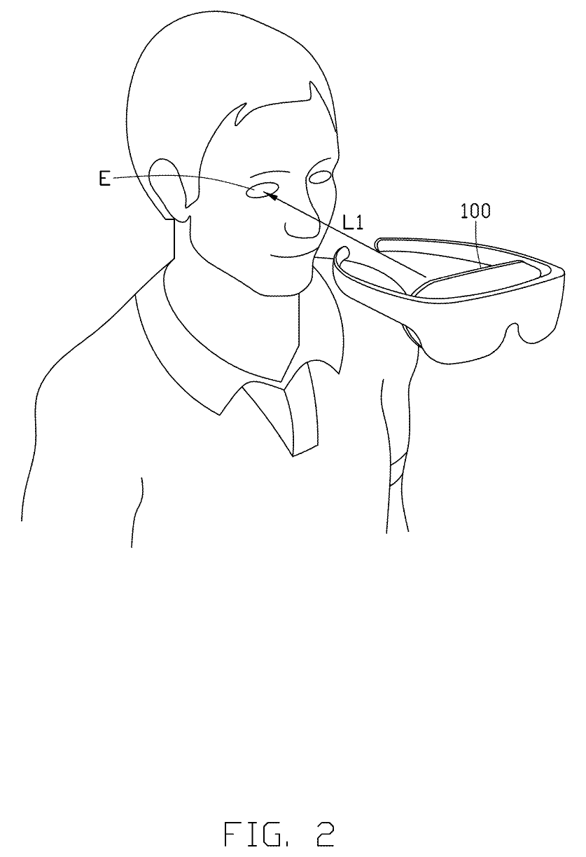

FIGS. 1 and 2 show a near-eye display device 100 of an embodiment of the present disclosure. The near-eye display device 100 includes a display screen 1, a light guide module 2, and a defocus lens 4. The display screen 1 is configured to emit an image light L1. The light guide module 2 is between the display screen 1 and the defocus lens 4 and is configured to receive and guide the image light L1. The defocus lens 4 is configured to receive the image light L1 exiting from the light guide module 2 and project the image light L1 to human eyes E.

The display screen 1 is on a side of the light guide module 2 away from the defocus lens 4. The display screen 1 can be, but is not limited to, a Liquid Crystal Display (LCD), a Micro-LED display, a Digital Light Processing (DLP) display, a Laser Beam Scanning (LBS) display, or an Active-Matrix Organic Light-Emitting Diode (AMOLED) display. The LCD can be, but is not limited to, a fast-response LCD, a Liquid Crystal on Silicon (LCoS) display. The AMOLED can be an OLED on Silicon display.

In one embodiment, the near-eye display device 100 is a virtual reality head-mounted display device. The light guide module 2 includes a first lens 21, a semi-reflective and semi-transmissive film 22 and a composite film layer 23. The semi-reflective and semi-transmissive film 22, the first lens 21 and the composite film layer 23 are arranged sequentially along an optical path of the image light L1.

In other embodiments, the light guide module 2 may further include a Fresnel lens or a freeform mirror on the optical path of the image light L1. In other embodiments, the near-eye display device 100 may be, but is not limited to, a mixed reality head-mounted display device.

The first lens 21 is configured to receive and guide the image light L1. A refractive index of the first lens 21 ranges from 1.3 to 2.1. In some embodiments, the refractive index of the first lens 21 can be, but is not limited to, any value within ranges such as 1.3 to 1.5, 1.5 to 1.7, 1.7 to 1.9, or 1.9 to 2.1.

The first lens 21 includes a first surface 211 and a second surface 213. In one embodiment, each of the first surface 211 and the second surface 213 is a convex surface, and each of the first surface 211 and the second surface 213 is an aspheric surface, meaning the first lens 21 is a biconvex aspheric lens. A radius of curvature of the first lens 21 ranges from 20mm to 5000mm. In some embodiments, the radius of curvature of the first lens 21 can be, but is not limited to, any value within ranges such as 20mm to 100mm, 100mm to 1000mm, 1000mm to 2000mm, 2000mm to 3000mm, 3000mm to 4000mm, or 4000mm to 5000mm.

A material of the first lens 21 is glass or plastic. For example, the material of the first lens 21 can be, but is not limited to, quartz glass. The first surface 211 of the first lens 21 or the second surface 213 of the first lens 21 may further be provided with an optical coating (not shown). A refractive index of the optical coating is between the refractive index of the first lens 21 and a refractive index of the defocus lens 4, used to achieve a refractive index transition. The optical coating can be, but is not limited to, an anti-reflection layer, an anti-smudge layer, and so on.

The semi-reflective and semi-transmissive film 22 is attached to the first surface 211. The semi-reflective and semi-transmissive film 22 is configured to partially transmit and partially reflect the image light L1. In some embodiments, a transmittance of the semi-reflective and semi-transmissive film 22 for the image light L1 is 50%, and a reflectance of the semi-reflective and semi-transmissive film 22 for the image light L1 is 50%.

In other embodiments, the transmittance of the semi-reflective and semi-transmissive film 22 for the image light L1 can be, but is not limited to, 60%, and the reflectance of the semi-reflective and semi-transmissive film 22 for the image light L1 can be, but is not limited to, 40%, as long as the semi-reflective and semi-transmissive film 22 can partially transmit and partially reflect the image light L1.

The composite film layer 23 is attached to the second surface 213 and is configured to receive and change a polarization state of the image light L1, so that the image light L1 exits towards the defocus lens 4. In some embodiments, the composite film layer 23 includes a phase retardation layer 231, a reflective polarizer 233, and a linear polarizer 235, arranged sequentially along a direction of the display 1 pointing to the defocus lens 4. The phase retardation layer 231 is closer to the second surface 213 than to the linear polarizer 235. The linear polarizer 235 is between the reflective polarizer 233 and the defocus lens 4. A transmission axis of the linear polarizer 235 is in a same direction as a transmission axis of the reflective polarizer 233. The linear polarizer 235 is configured to allow light of a specific polarization direction to pass through. By setting the transmission axis of the linear polarizer 235 to be in the same direction as the transmission axis of the reflective polarizer 233, the image light L1 exiting from the reflective polarizer 233 can pass through the linear polarizer 235 and then enter the human eyes E, while filtering out other stray light.

In one embodiment, the image light L1 is circularly polarized light, meaning the polarization state of the image light L1 is a circular polarization state. For example, the image light L1 can be left-handed or right-handed circularly polarized light. The image light L1 passes through the first lens 21 and is incident on the semi-reflective and semi-transmissive film 22.

When incident on the semi-reflective and semi-transmissive film 22, half of the energy of the image light L1 passes through the film and is incident on the composite film layer 23. After the image light L1 is incident on the composite film layer 23, the phase retardation layer 231 converts the image light L1 from the circular polarization state to the linear polarization state. The image light L1 that passes through the phase retardation layer 231 for the first time is reflected by the reflective polarizer 233.

After passing through the phase retardation layer 231 for the second time, the image light L1 is again incident on the semi-reflective and semi-transmissive film. A portion of the image light L1 (at this time, the energy of the image light L1 is one-fourth of that before entering the first lens 21) is reflected by the semi-reflective and semi-transmissive film back to the composite film layer 23. After passing through the phase retardation layer 231 for the third time, the linearly polarized image light L1 continues to pass through the reflective polarizer 233 and the linear polarizer 235, whose transmission axis is in the same direction as that of the reflective polarizer 233, and finally enters the human eyes E.

In other embodiments, the image light L1 can be, but is not limited to, in a linear polarization state. The near-eye display device 100 further includes a first adhesive layer 5 between the light guide module 2 and the defocus lens 4. The first adhesive layer 5 fills a space between the first defocus surface 41 and the light guide module 2, to bond the light guide module 2 and the defocus lens 4. In some embodiments, the first adhesive layer 5 bonds the linear polarizer 235 and the first defocus surface 41.

In some embodiments, the first adhesive layer 5 can be, but is not limited to, Optically Clear Adhesive (OCA) or Liquid Optical Clear Adhesive (LOCA). By providing the first adhesive layer 5, which fills the space between the first defocus surface 41 and the light guide module 2, the light guide module 2 and the defocus lens 4 can be bonded more securely.

As shown in FIGS. 1, 3, and 4, the defocus lens 4 includes a first defocus surface 41 and a second defocus surface 43 opposite to the first defocus surface 41. The defocus lens 4 is configured to receive the image light L1 exiting from the light guide module 2 and project the image light L1 to the human eyes E. The refractive index of the defocus lens 4 ranges from 1.3 to 2.1. In some embodiments, the refractive index of the defocus lens 4 can be, but is not limited to, any value within ranges such as 1.3 to 1.5, 1.5 to 1.7, 1.7 to 1.9, or 1.9 to 2.1.

Each of the first defocus surface 41 and the second defocus surface 43 is convex towards the display screen 1, and each of the first defocus surface 41 and the second defocus surface 43 is an aspheric surface, meaning the defocus lens 4 is a biconvex aspheric lens. A radius of curvature of the defocus lens 4 ranges from 20mm to 5000mm.

In some embodiments, the radius of curvature of the defocus lens 4 can be, but is not limited to, any value within ranges such as 20mm to 100mm, 100mm to 1000mm, 1000mm to 2000mm, 2000mm to 3000mm, 3000mm to 4000mm, or 4000mm to 5000mm.

In some embodiments, a material of the defocus lens 4 is glass or plastic .For example, the material of the defocus lens 4 can be, but is not limited to, quartz glass. The first defocus surface 41 of the defocus lens 4 and the second defocus surface 43 of the defocus lens 4 may further be provided with an optical coating (not shown). A refractive index of the optical coating on the defocus lens 4 is between the refractive index of the first lens 21 and the refractive index of the defocus lens 4, used to achieve a refractive index transition. The optical coating on the defocus lens 4 can be, but is not limited to, an anti-reflection layer, an anti-smudge layer, and so on.

In some embodiments, the first defocus surface 41 includes a central region 411 at a center of the first defocus surface 41 and a peripheral region 412 surrounding the central region 411. The defocus lens 4 includes a plurality of microlenses 413 in the peripheral region 412. The central region 411 is configured to receive the image light L1 and focus a first portion of the image light L1 at a first focal plane. The plurality of microlenses 413 is configured to focus a second portion of the image light L1 incident outside the central region 411 at a second focal plane. The second focal plane is positioned between the defocus lens 4 and the first focal plane. The first focal plane can be a retina E1 of an eye E of a user, and the second focal plane can be a plane in front of the retina E1 of the eye E of the user.

In one embodiment, the central region 411 is circular. In other embodiments, a shape of the central region 411 can be, but is not limited to, rectangular, triangular, polygonal, or other irregular shapes, as long as the central region 411 can receive the image light L1 and focus the image light L1 onto the retina E1 of the human eyes E.

In some embodiments, a diameter d1 of the central region 411 satisfies: 0mm < d1 < 8mm, meaning the diameter d1 of the central region 411 is greater than zero (0) and less than 8mm. In some embodiments, the diameter d1 of the central region 411 can be, but is not limited to, any value within ranges such as 0.1mm to 1mm, 1mm to 3mm, 3mm to 5mm, 5mm to 7mm, or 7mm to 8mm.

By setting the central region 411 of an appropriate size, it is conducive to focusing the image light L1 of a suitable intensity onto the retina E1 of the human eyes E. To improve the light transmittance of the central region 411, the central region 411 can further be, but is not limited to, coated with an anti-reflection coating (not shown) to further increase a transmittance of the image light L1.

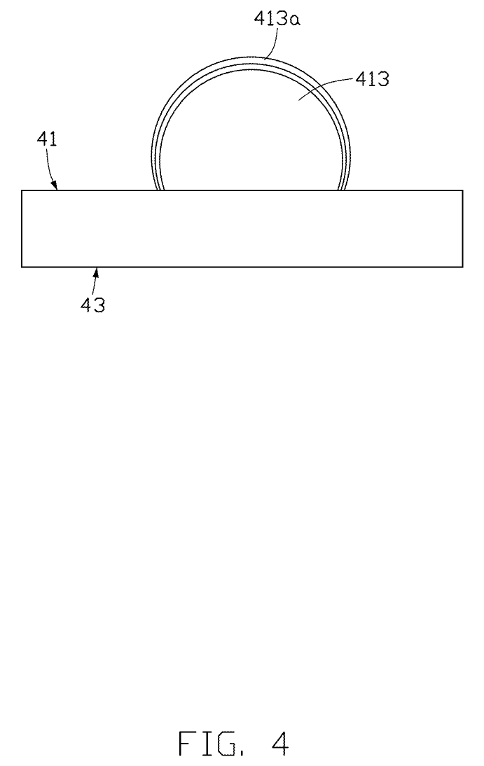

Each of the microlens 413 is convex towards the display screen 1. In some embodiments, as shown in FIG. 4, the defocus lens 4 further includes an anti-reflection and transmission-enhancing film 413a coated on a surface of each microlens 413 facing to the light guide module 2. The anti-reflection and transmission-enhancing film 413a is configured to reduce a reflectance of the image light L1 on the microlens 413 and increase the transmittance of the image light L1 through the microlens 413.

A defocus amount of each microlens 413 ranges from 2.0 diopters to 5.0 diopters. In some embodiments, the defocus amount of each microlens 413 can be, but is not limited to, any value within ranges such as 2.0 diopters to 3.0 diopters, 3.0 diopters to 4.0 diopters, or 4.0 diopters to 5.0 diopters.

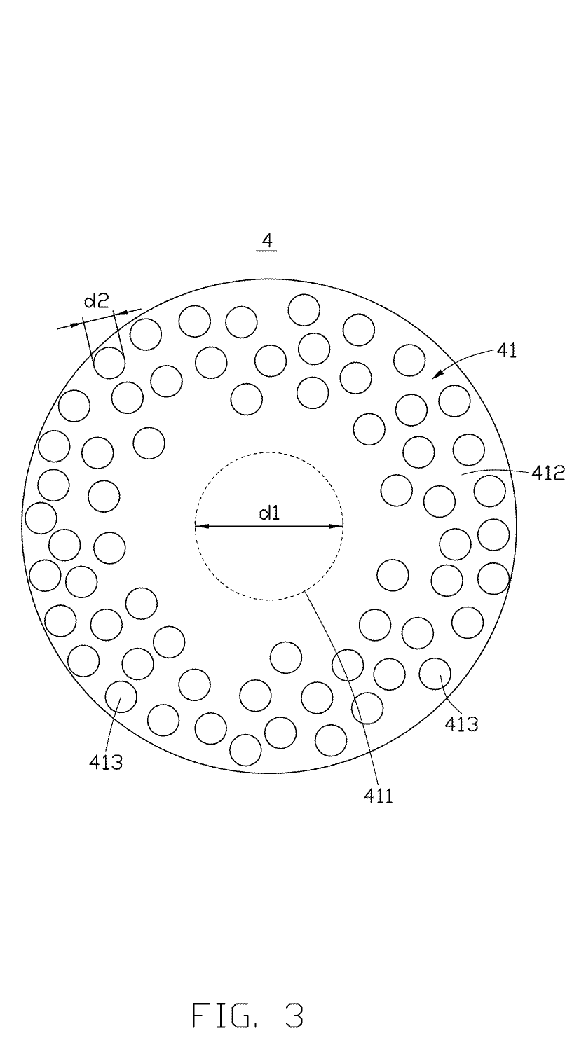

In one embodiment, as shown in FIGS. 1 and 3, each microlens 413 is spherical, and a contact surface between each microlens 413 and the first defocus surface 41 is circular. The microlenses 413 are randomly arranged the peripheral region 412 of the first defocus surface 41. A spatial density of the microlenses 413 on the first defocus surface 41 gradually increases in a direction away from the central region 411. The spatial density of the microlenses 413 further from the central region 411 is higher than the spatial density of the microlenses 413 closer to the central region 411. That is, the spatial density of the microlenses 413 increases with distance from the central region 411.

By setting the spatial density of the microlenses 413 on the first defocus surface 41 to gradually increase in the direction away from the central region 411, an overall defocus amount of the defocus lens 4 gradually increases with the spatial density of the microlenses 413 in the direction away from the central region 411. That is, the defocus amount at a periphery of the defocus lens 4 is greater than the defocus amount at an inner part of the defocus lens 4. This allows a focal position of the image light L1 entering the human eyes E from the defocus lens 4 to adapt to a shape of the human eyes E, thereby further reducing the probability of stimulating the elongation of the axial length, which is beneficial for slowing the progression of myopia in myopic users.

A diameter d2 of each microlens 413 satisfies: 0mm < d2 < 3mm, that is, the diameter d2 of each microlens 413 is greater than zero (0) and less than 3mm. In some embodiments, the diameter d2 of each microlens 413 can be, but is not limited to, any value within ranges such as 0.1mm to 1mm, 1mm to 2mm, or 2mm to 3mm.

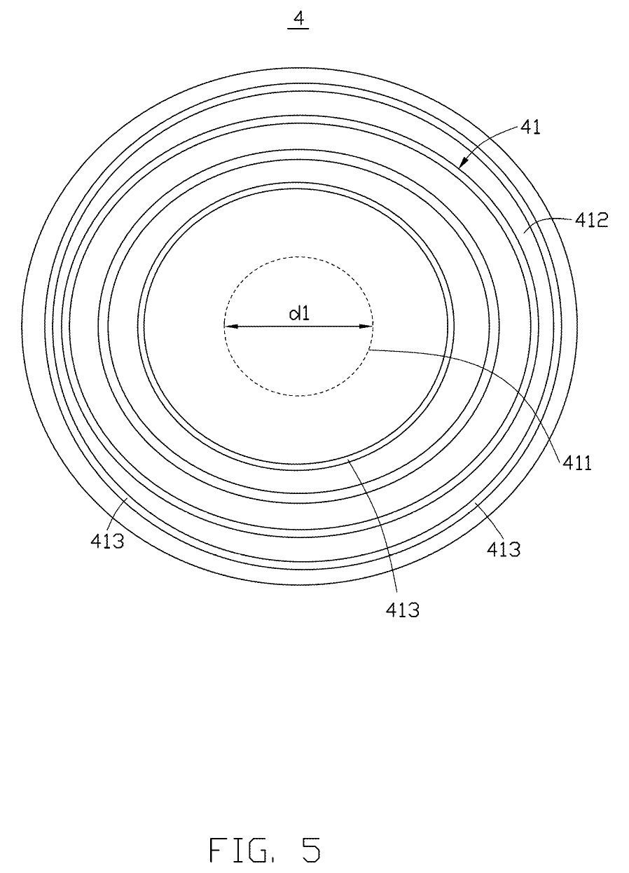

As shown in FIG. 5, in another embodiment, the contact surface between each microlens 413 and the first defocus surface 41 is annular. The microlenses 413 are arranged as a series of concentric rings around the central region 411, and a spacing between any adjacent two microlenses 413 gradually decreases in a direction away from the central region 411. A spacing between the concentric rings further from the central region 411 is less than a spacing between the concentric rings closer to the central region 411. In other words, the spacing between concentric rings decreases with distance from the central region 411. By providing the central region 411 and the microlenses 413 on the first defocus surface 41 of the defocus lens 4, the central region 411 is configured to receive the image light L1 and focus the image light L1 onto the retina E1 of the human eyes E, and the microlenses 413 are configured to simultaneously focus the incident image light L1 in front of the retina E1 of the human eyes E.

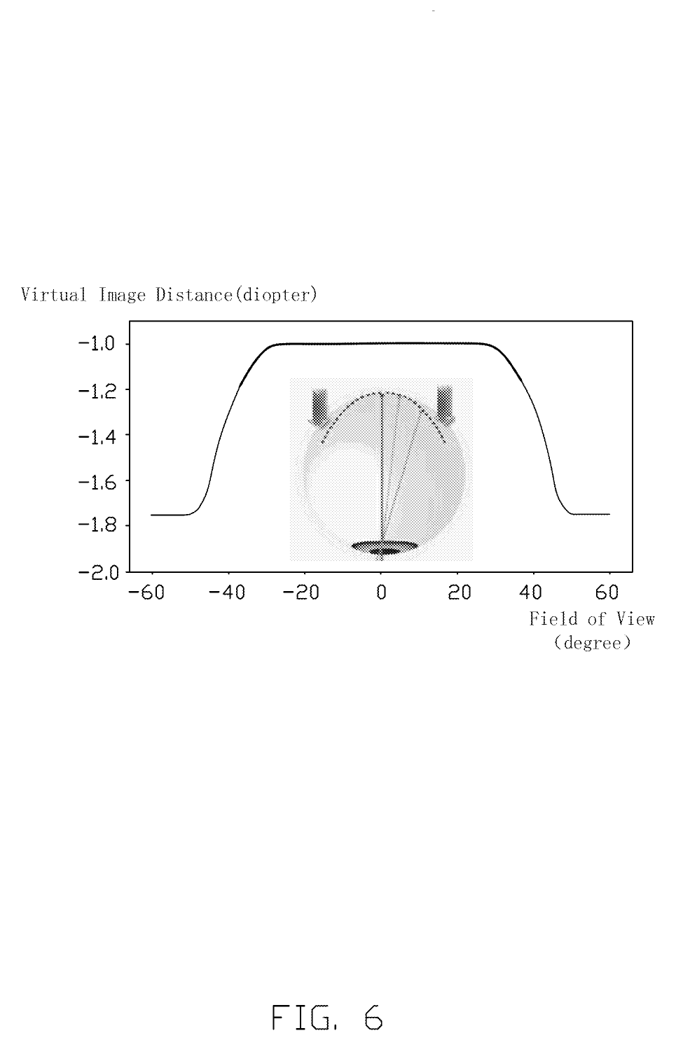

FIG. 6 is a curve showing a relationship between virtual image distance (VID) with different field of view angles of the near-eye display device 100, simulating an observation effect of the human eyes E. As shown in FIG. 6, the virtual image distance decreases as an absolute value of the field of view angle increases, which means the distance from a projected virtual image to a pupil of the human eye first increases and then decreases. Thus, a portion of the image light L1 exiting from the near-eye display device 100 can be focused on the retina E1, and a portion of the image light L1 is focused in front of the retina E1 of the human eyes E. While ensuring clear vision for the human eyes E, this design can effectively reduce a stimulation to an axial length of the human eyes E, thus helping to lower a probability of stimulating axial length elongation and, consequently, slowing a progression of myopia in myopic users.

As shown in FIGS. 1 and 2, the near-eye display device 100 is provided with the defocus lens 4, the first defocus surface 41 of the defocus lens 4 is provided with the central region 411 and the microlenses 413 surrounding the central region 411, each microlens 413 protrudes towards the display screen 1, the central region 411 is used to receive a portion of the image light L1 and focus the portion of the image light L1 onto the retina E1 of the human eyes E, and the microlenses 413 are configured to focus another portion of the image light L1 incident outside the central region 411 in front of the retina E1 of the human eyes E. While ensuring clear vision for the human eyes E, the stimulation to the axial length of the human eyes E, can be effectively reduced, thus being beneficial to reducing the probability of stimulating axial length elongation. When a myopic person uses the aforementioned near-eye display device 100, it is beneficial for slowing the progression of myopia in the user’s eyes E.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A near-eye display device, comprising:
a display screen configured to emit an image light;
a light guide module optically coupled to the display screen and configured to guide the image light;
a defocus lens positioned to receive the image light from the light guide module and comprising a first defocus surface facing the light guide module and a second defocus surface opposite the first defocus surface;
wherein the first defocus surface comprises a central region and a peripheral region surrounding the central region, the defocus lens further comprises a plurality of microlenses, and each of the plurality of microlenses is convex towards the display screen;
the central region of the first defocus surface is configured to focus a first portion of the image light onto a retina of an eye of a user, and the plurality of microlenses is configured to focus a second portion of the image light in front of the retina of the eye of the user.

2. The near-eye display device of claim 1, wherein each of the first defocus surface and the second defocus surface is an aspheric surface.

3. The near-eye display device of claim 1, wherein the light guide module comprises a semi-reflective and semi-transmissive film, a first lens, and a composite film layer, arranged sequentially along a direction from the display screen to the defocus lens; the first lens comprises a first surface facing the display screen and a second surface opposite to the first surface, the semi-reflective and semi-transmissive film is attached to the first surface and is configured to partially transmit and partially reflect the image light, and the composite film layer is attached to the second surface and configured to change a polarization state of the image light.

4. The near-eye display device of claim 4 wherein each of the first surface and the second surface is a convex surface.

5. The near-eye display device of claim 3, wherein the composite film layer comprises a phase retardation layer and a reflective polarizer, and the phase retardation layer is positioned closer to the second surface of the first lens than to the reflective polarizer.

6. The near-eye display device of claim 5, wherein the composite film layer further comprises a linear polarizer positioned between the reflective polarizer and the defocus lens, and a transmission axis of the linear polarizer is aligned with a transmission axis of the reflective polarizer.

7. The near-eye display device of claim 3, wherein a refractive index of the first lens ranges from 1.3 to 2.1.

8. The near-eye display device of claim 1, wherein the central region is circular and has a diameter greater than zero (0) and less than 8 mm.

9. The near-eye display device of claim 1, further comprising an anti-reflection and transmission-enhancing film on a surface of each of plurality of the microlenses facing the light guide module.

10. The near-eye display device of claim 1, wherein the plurality of microlenses is randomly arranged on the peripheral region of the first defocus surface.

11. The near-eye display device of claim 10, wherein a spatial density of the plurality of microlenses on the first defocus surface further from the central region is higher than a spatial density of the plurality of microlenses closer to the central region.

12. The near-eye display device of claim 11, wherein each of the plurality of microlenses is spherical, and a contact surface between each of the plurality of microlenses and the first defocus surface is circular.

13. The near-eye display device of claim 11, wherein a diameter of each of the plurality of microlenses is greater than zero (0) and less than 3 mm.

14. The near-eye display device of claim 1, wherein the plurality of microlenses is arranged in a series of concentric rings around the central region.

15. The near-eye display device of claim 14, wherein a spacing between the concentric rings further from the central region is less than a spacing between the concentric rings closer to the central region.

16. The near-eye display device of claim 1, wherein a defocus amount provided by each of the plurality of microlenses ranges from 2.0 diopters to 5.0 diopters.

17. The near-eye display device of claim 1, further comprising an adhesive layer bonding the light guide module to the first defocus surface of the defocus lens.

18. The near-eye display device of claim 1, wherein a refractive index of the defocus lens ranges from 1.3 to 2.1.

19. A near-eye display device, comprising:
a display screen configured to emit an image light;
a light guide module optically coupled to the display screen and configured to guide the image light;
a defocus lens positioned to receive the image light from the light guide module and comprising a first defocus surface facing the light guide module and a second defocus surface opposite the first defocus surface; each of the first defocus surface and the second defocus surface being an aspheric surface;
wherein the first defocus surface comprises a central region and a peripheral region surrounding the central region; the defocus lens further comprises a plurality of microlenses, each of the plurality of microlenses is convex towards the display screen; the central region of the first defocus surface is configured to focus a first portion of the image light at a first focal plane, the plurality of microlenses is configured to focus a second portion of the image light at a second focal plane, and the second focal plane is positioned between the defocus lens and the first focal plane.

20. The near-eye display device of claim 19, wherein the light guide module comprises a semi-reflective and semi-transmissive film, a first lens, and a composite film layer, arranged sequentially along a direction from the display screen to the defocus lens; the first lens comprises a first surface facing the display screen and a second surface opposite to the first surface; each of the first surface and the second surface is a convex surface; the semi-reflective and semi-transmissive film is attached to the first surface and is configured to partially transmit and partially reflect the image light, and the composite film layer is attached to the second surface and configured to change a polarization state of the image light.
